(19) United States
(12) Patent Application Publication
(10) Pub. No.: US 2022/0218010 A1
(43) Pub. Date: Jul. 14, 2022

(54) CO-ATOMISED LEGUME PROTEIN WITH REDUCED FLAVOUR

(71) Applicant: ROQUETTE FRERES, Lestrem (FR)

(72) Inventors: Bernard CAULIER, FRETIN (FR); Christophe LAROCHE, FOUGERES (FR); Mathias IBERT, CHAPELLE D'ARMENTIERES (FR)

(21) Appl. No.: 17/595,689

(22) PCT Filed: May 29, 2020
(86) PCT No.: PCT/FR2020/050925

§ 371 Date: Nov. 22, 2021

(30) Foreign Application Priority Data
May 29, 2019 (FR) FR1905754

(51) Int. Cl. A23L 33/185; A23J 3/14

(52) U.S. Cl. CPC A23L 33/185; A23J 3/14

(57) ABSTRACT

The invention relates to the field of legume proteins and in particular the organoleptic improvement of the proteins. The invention particularly relates to a method for co-atomizing a legume protein composition and at least one flavoring, comprising the steps of dissolving and mixing a legume protein composition and at least one flavoring in an aqueous solvent, heat-treating the aqueous suspension obtained and drying, by co-atomization, the aqueous suspension which has been heat-treated. When the different steps are carried out, the method according to the invention allows a synergistic effect to be obtained in the reduction of the legume flavor of the proteins. The invention also relates to a co-atomized composition comprising a legume protein composition and at least one flavoring, and to its use in preparing human or animal food compositions.

### TECHNICAL FIELD

The invention relates to the field of legume proteins, in particular of legume protein isolates, even more particularly of pea protein isolates. The invention relates in particular to the field of organoleptic improvement, in particular of the flavor, of the aforementioned proteins.

### BACKGROUND ART

Human daily requirements for proteins are between 12 and 20% of food intake. These proteins are provided equally by products of animal origin (meat, fish, eggs, dairy products) and by plant-based food (cereals, leguminous plants, seaweed).

However, in developed countries, protein intake is predominantly in the form of proteins of animal origin. And yet, numerous studies show that excessive consumption of proteins of animal origin to the detriment of plant proteins is one of the causes of increases in cancer and cardiovascular diseases.

Moreover, animal proteins have many drawbacks, both in terms of their allergenicity, notably regarding proteins from milk or eggs, and in environmental terms, in connection with the harmful effects of intensive farming.

Thus, there is an increasing demand from manufacturers for compounds of plant origin having beneficial nutritional and functional properties without, however, having the disadvantages of compounds of animal origin.

Soybean has been, and still is, the main plant alternative to animal proteins. However, the use of soybean presents certain drawbacks. The origin of soybean seeds is more often than not from GMOs and the production of its protein proceeds via a de-oiling step which uses solvent.

Since the 1970s, the development of pulse plants, in particular including pea, in Europe and mainly in France, has dramatically increased as an alternative protein resource to animal proteins for animal and human food consumption. The term “pea” is considered here in its broadest accepted use and includes, in particular, all the wild varieties of “smooth pea” and all the mutant varieties of “smooth pea” and “wrinkled pea”, regardless of the uses for which said varieties are usually intended (human food, animal feed and/or other uses). These seeds are non-GMOs and do not require a de-oiling step using solvents.

The pea contains approximately 27% by weight of protein substances. Pea protein, predominantly pea globulin, has been extracted and utilized industrially for a great number of years. Mention may be made, as an example of a method for extracting pea protein, of patent EP1400537. In this process, the seed is milled in the absence of water (process referred to as “dry milling”) in order to obtain a flour. This flour will then be suspended in water in order to extract the protein therefrom.

Legume proteins, and in particular pea proteins, often suffer from variable organoleptic quality. Indeed, they are particularly known to give off a flavor referred to as “pea”, “beany” or even “vegetable” when they are consumed, which can be a disadvantage in certain food products.

This flavor is caused by the oxidation of the internal lipids of the legume seeds by lipoxygenase, leading to the appearance of aldehyde- and ketone-like molecules such as hexanal.

In addition, the legume proteins are also frequently the source of the bitter taste or bitterness. This taste appears to be provided mainly by the presence of saponins.

Users of these legume proteins are aware of these flavor issues and have developed formulation strategies based mainly on the use of flavorings.

One example that can be cited is patent application WO 2019/048564 from RHODIA, which teaches that the use of a vanilla flavoring reduces the bitter taste in a finished food product such as a high-protein drink or cream. However, this solution only works in part because the manufacturer is forced to add a flavoring in addition to the protein in the preparation of the recipe, which makes the task more complex, and it is the formulation itself as a whole that acts as a masking agent, not the addition of the flavoring specifically.

Indeed, the presented recipes between 20% and 50% of non-protein compounds such as sucralose, high-intensity sweetener or fructose. This formulation likewise acts by limiting the detection of flavors but also contributes to a high calorie intake and an obligation to be mentioned on the label of the finished product.

Another solution has been described in WO2019/048804 to obtain a food product based on legume proteins, for example a ready-to-drink beverage, with improved organoleptic properties. This solution is based on a particular method for manufacturing the food product using a selected compound: sodium citrate. Again, this solution requires the manufacturer to use this particular compound.

It is therefore of interest to propose novel legume protein compositions, in particular a legume protein isolate, the flavor of which is improved, in particular the reduction of its “pea” note, and the use of which is both simple and immediate, without an overly cumbersome and/or complicated formulation.

The article by Lan et al. “Solid dispersion-based spray-drying improves solubility and mitigates beany flavor of pea protein isolate” (Food Chemistry, 2018) presents some recent work on this matter. Lan's team has developed a method referred to as “solid dispersion spray” consisting of an aqueous dispersion of pea protein and guar gum or maltodextrin dried by atomization. With a minimum content of 10% dry/dry of maltodextrin or guar gum, the pea protein isolate obtained has a less present “pea” flavor, due to its lower content of volatile compounds. Document FR 2942585 A1 describes granulated compositions of pea proteins and soluble plant fibers, wherein the plant fiber may also be a maltodextrin.

Nevertheless, the maltodextrin content here is also too high and it is not desirable to have such a large amount of a compound of non-protein origin as a supplement to the pea protein isolate. As exemplified in the present invention, lowering this content leads to the disappearance of this masking effect. Furthermore, maltodextrin has a fairly neutral taste and odor and does not meet the definition of a flavoring, which is confirmed by the fact that it is not included in regulatory lists of flavorings.

Other strategies consist in processing the raw material, as for example in the document Jiang et al., Faba bean flavor and technological property improvement by thermal pre-treatments, LWT—Food Science and Technology, 68 (2016), 295-305. This document teaches, in order to preserve the properties of the faba bean proteins, to use a particular microwave treatment. However, this type of microwave treatment has not yet been developed on an industrial scale.

Document WO03/082026 A1 describes a method for producing a protein isolate further comprising a polysaccharide having a neutral flavor and a low water absorption rate, these two properties being provided to the isolate by coating the protein with the polysaccharide.

There is therefore a need to develop novel legume protein compositions, in particular a legume protein isolate, which do not have the disadvantages of previous compositions, the flavor of which is improved by reducing the pea flavor, and the use of which is both simple and immediate, without an overly cumbersome and/or complicated formulation, while also minimizing the amounts of compound of non-protein origin used.

Pea protein compositions with improved flavor, using particular manufacturing methods, have been described in WO 2019/053387 A1.

After much research, the applicant has identified that this goal could be achieved by implementing a particular method of co-atomizing a legume protein composition and at least one flavoring.

### GENERAL DESCRIPTION OF THE INVENTION

According to a first aspect of the invention, a method is proposed for co-atomizing a legume protein composition and at least one flavoring comprising the following steps of:

1) dissolving and mixing a legume protein composition and at least one flavoring in an aqueous solvent;
2) heat-treating the aqueous suspension obtained in the previous step;
3) drying, by co-atomization the aqueous suspension that has been heat-treated.

According to a second aspect, a co-atomized composition is proposed comprising a legume protein composition, preferentially a legume protein isolate and at least one flavoring, said composition being obtainable according to the method of the invention.

According to a final aspect of the invention, the use of this co-atomized composition is proposed in preparing compositions intended for human or animal food.

### DETAILED DESCRIPTION OF THE INVENTION

According to a first aspect, the invention thus relates to a method for co-atomizing a legume protein composition and at least one flavoring comprising the following steps of:

1) dissolving and mixing a legume protein composition and at least one flavoring in an aqueous solvent;
2) heat-treating the aqueous suspension obtained in the previous step;
3) drying, by co-atomization the aqueous suspension that has been heat-treated.

In an altogether surprising manner, the method according to the invention by mixing a legume protein composition with at least one flavoring and then carrying out a heat-treatment step followed by co-atomization, makes it possible to reduce the flavor of said legume composition.

This reduction of the legume flavor, in particular of peas in the case of using a pea protein composition, is obtained in a synergistic manner by the combination of three characteristics, namely the mixing of the legume protein composition with at least one flavoring, a heat-treatment step and a co-atomization step. Indeed, the combination of these three characteristics allows a greater reduction of the legume flavor, particularly of peas, than the sum of the reductions obtained by these characteristics taken in isolation.

“Co-atomized” is understood in the present invention to mean that the legume protein composition is atomized together with the flavoring(s). In other words, the legume protein composition and the flavoring are present in the same solution before atomization.

The term “protein composition” is understood in the present invention to mean a composition obtained by extraction and refining, said composition comprising proteins, macromolecules formed from one or more polypeptide chains consisting of a sequence of amino acid residues linked together via peptide bonds. In the particular context of pea proteins, the present invention relates more particularly to globulins (about 50-60% of the pea proteins). Pea globulins are mainly subdivided into three sub-families: legumins, vicilins and convicilins.

“Legume” is understood in the present invention to mean the family of dicotyledonous plants of the Fabales order. This is one of the largest flowering plant families, third after Orchidaceae and Asteraceae in terms of number of species. It contains approximately 765 genera, bringing together more than 19,500 species. Several leguminous plants are important crop plants, including soy, beans, peas, chickpeas, faba beans, peanuts, cultivated lentils, cultivated alfalfa, various clovers, broad beans, carob and licorice.

“Flavoring” is understood in the present invention to mean any chemical compound making it possible to modify the perception of taste and smell, which together form what is known as “flavor”. European legislation, as defined by Regulation 1334/20082, understands flavorings to be “products not intended to be consumed as such, which are added to food in order to impart or modify odor and/or taste” (Article 3.a of Regulation EC 1334/2008). The flavoring useful in the invention has the ability to reduce the “pea” note of the legume protein composition.

Flavorings are derived from or consist of the following components: flavoring substances, flavoring preparations, smoke flavorings, thermal process flavorings, flavor precursors and other flavorings.

In the context of the present invention, flavoring is preferentially understood to mean a flavoring substance. A flavoring substance is a “defined chemical substance with flavoring properties” (definition in Article 3.b of Regulation EC 1334/2008).

A natural flavoring substance is “obtained by appropriate physical, enzymatic or microbiological processes, from material of vegetable, animal or microbiological origin either in the raw state or after processing for human consumption by one or more of the traditional food preparation processes listed in Annex II” (Article 3.c of Regulation EC 1334/2008).

Natural flavoring substances correspond to substances that are naturally present and have been identified in nature. The flavoring substances can also be derived from natural sources other than the “raw” natural source, it is then a matter of synthesizing the molecule and reproducing it. Other molecules, that have not been identified in nature, can also have a more powerful taste than natural molecules.

The method according to the invention uses at least one flavoring, that is a flavoring or a mixture of flavorings.

The method according to the invention thus comprises a step 1) of dissolving and mixing a legume protein composition and at least one flavoring in an aqueous solvent.

The mixing between the legume protein composition and at least one flavoring may be carried out separately in two aqueous solvents which will be mixed afterwards or together before being dispersed in an aqueous solvent.

According to one particular embodiment, the aqueous solvent is preferably water.

The dissolution temperature is preferentially between 10° C. and 40° C., preferentially between 20° C. and 30° C. The dissolution pH is preferentially between 4 and 9, even more preferentially between 6 and 8, and even more preferentially 7.

The dissolution time is chosen in order to obtain a homogeneous solution. It is preferentially chosen between 1 and 60 minutes, preferentially between 2 and 30 minutes, and even more preferentially between 3 and 10 minutes.

The at least one flavoring may be mixed and dissolved in the legume protein composition in an amount of less than 5% by weight relative to the total dry weight of the legume protein composition (dry/dry), or even less than 1% by weight (dry/dry), particularly from 0.01 to 1% by weight (dry/dry). Advantageously, the at least one flavoring may be mixed and dissolved in the legume protein composition in an amount of 0.01 to 0.5% by weight (dry/dry), preferentially 0.05 to 0.2% by weight (dry/dry), and even more preferentially, in an amount of 0.1% by weight (dry/dry).

The use of these small amounts of flavoring is particularly interesting because it is advantageous to be able to maintain amounts of less than 5% by weight with respect to the total dry weight of the legume protein composition (dry/dry), even less than 1% by weight (dry/dry), in particular from 0.01 to 1% by weight (dry/dry), for example from 0.01 to 0.5% by weight (dry/dry), preferentially from 0.05 to 0.2% by weight (dry/dry), and even more preferentially, in an amount of 0.1% by weight (dry/dry) in the mixture in order to limit, at the end of the method, the proportion of compounds of non-protein origin present as a supplement in the powder.

The flavoring is chosen from the list of different flavorings available in the food industry. This one is preferentially chosen from the list of vanilla, strawberry or caramel flavorings. Preferentially, the vanilla flavoring is preferred.

The flavorings may comprise aliphatic, alicyclic, aromatic, heterocyclic and/or terpene compounds. Among the aliphatic compounds, they can be chosen from hydrocarbons, ethers, aldehydes, ketones, alcohols, esters, acids, amines, sulfides, thiols and thioesters. The flavorings may also include cyclic derivatives (cyclotenes) and aromatics (phenols). The heterocycles may be pyrazines, lactones, oxazoles, thiazoles, pyrroles, pyridines, pyrans, pyrimidines and the condensed derivatives thereof. The terpenes can be mono- and sesquiterpenes. Preferably, the flavorings are chosen from aromatic compounds and heterocycles.

The flavoring may also be preferentially chosen from the list of different flavor maskers available in the food industry, such as for example Springer® Mask 101 marketed by Lesaffre. A flavor masking compound is known to be a flavoring selected for its specific ability to block, mask or modify undesirable notes. Thus, the flavorings mentioned above can also have these functions.

Flavor maskers may be chosen from fatty acids, compounds comprising carbonyl functions, compounds comprising sulfides, sweet brown flavors, ester compounds, lactone compounds or juice derivatives, preferably sweet brown flavors. The fatty acids may be chosen from the following acids: nonanoic acid, decanoic acid, dodecanoic acid, tetradecanoic acid, hexadecanoic acid, oleic acid, octanoic acid, 9-decenoic acid and hexanoic acid. The compounds comprising carbonyl functions may be chosen from the following compounds: acetoin, acetylpropionyl, 2-heptanone, 2-nonanone, 2-undecanone and cis-4-heptenal. The compounds comprising sulfides may be chosen from the following compounds: dimethyl sulfide and dimethyl trisulfide. The sweet brown flavors may be chosen from the following compounds: maltol, vanillin, cyclopentenolone, furaneol, vanilla extracts, vanilla derivatives, caramel extracts and condensed milk derivatives. The ester compounds may be chosen from the following compounds: ethyl caprate, ethyl dodecanoate, ethyl myristate, ethyl palmitate and ethyl oleate. The lactone compounds may be chosen from the following compounds: gamma decalactone, delta decalactone, delta dodecalactone, gamma undecalactone and massoia lactone. The juice derivatives may be chosen from the following fruit juice derivatives: strawberry, cucumber, apple, cherry, kiwi and apricot. Preferably, the flavor masker comprises sweet brown flavors, which are particularly effective in masking the flavor of pea proteins.

Preferentially, the flavoring useful for the invention is not found in the original legume protein composition.

According to a particular embodiment, the legume protein composition is a protein isolate. Any commercially available legume protein isolate is a sufficient basis for carrying out the method of the invention. A legume protein isolate may also be obtained by virtue of known methods of the prior art such as those described in documents EP 1 909 593 or WO 2015/071499.

According to a preferred embodiment, the legume protein composition is a legume protein isolate chosen from pea, lupin and faba bean. Preferably, the legume protein composition is a pea protein isolate.

The term “pea” is considered here in its broadest accepted use and includes, in particular, all the wild varieties of “smooth pea” and all the mutant varieties of “smooth pea” and “wrinkled pea”, regardless of the uses for which said varieties are usually intended (human food, animal feed and/or other uses).

The term “pea” in the present application includes pea varieties belonging to the Pisum genus and more particularly to the species sativum and aestivum.

In a preferential manner, the legume protein composition according to the invention has a total protein content greater than 80% by weight, preferentially greater than 85% by weight, and even more preferentially greater than 90% by weight relative to the total solids of said composition.

The total protein content is measured by any technique well known to a skilled person. Preferably, the total nitrogen (in %/crude) is assayed, and the result is multiplied by the coefficient 6.25; this is the Kjeldahl method. This well-known methodology in the field of plant proteins is based on the observation that proteins contain on average 16% nitrogen.

In a preferential manner, the legume protein composition according to the invention has a solids content greater than 80% by weight, preferentially greater than 85% by weight, even more preferentially greater than 90% by weight relative to the total weight of the composition.

Any method for measuring water content may be used to quantify these solids, the gravimetric technique evaluating water loss through drying being preferred.

This gravimetric technique consists in determining the amount of water evaporated by heating a known amount of a sample of known weight. The protocol is as follows:
the sample is first weighed and a mass m1 is measured in grams,
the water is evaporated off by placing the sample in a heated chamber until the mass of the sample has stabilized, the water being completely evaporated off. Preferably, the temperature is 105° C. at atmospheric pressure, or around 1013 hPa,
the final sample is weighed and a mass m2 is measured in grams.
   The solids are then determined using the following formula: (m2/m1)×100.

The method according to the invention also comprises a step 2) of heat-treating the aqueous suspension obtained in step 1).

The heat-treatment step may advantageously be carried out at a temperature between 100° C. and 160° C. and for 0.01 to 10 seconds, preferentially between 5 and 8 seconds, followed by immediate cooling.

Any equipment well known to a skilled person for obtaining these temperatures may be used. However, the use of steam injection nozzles or plate heat exchangers is preferred.

The method according to the invention comprises a step 3) in which the heat-treated aqueous suspension is dried by atomization.

According to a particular embodiment, the atomization of the heat-treated aqueous suspension is carried out so as to obtain solids of more than 80%, preferentially more than 90%.

Atomization is understood in the present invention to mean any method of dehydrating a liquid into powder form by passing it through a stream of hot air. The liquid is preferentially dispersed in the hot air by dispersing it in fine droplets using a nozzle system.

According to step 3) of the method of the invention, atomization is preferentially carried out in a so-called “multi-effect” or “multi-stage” atomizer system allowing the dried product to be recirculated in input, in order to granulate and thus increase the particle size.

The air inlet temperature of the atomizer is preferentially from 180° C. to 240° C., preferentially from 190° C. to 220° C., and even more preferentially from 200° C. to 210° C.

The air outlet temperature of the atomizer is preferentially from 60° C. to 110° C., preferentially from 70° C. to 100° C., and even more preferentially from 80° C. to 90° C.

After this step 3) a powder is obtained and it corresponds to the protein composition co-atomized with the flavoring.

According to a particular embodiment, the composition obtained by the method of the invention consists of a legume protein composition and at least one flavoring. In other words, according to this embodiment, the method of the invention only uses, in addition to the aqueous solvent, one legume protein composition and at least one flavoring.

According to a variant of this particular embodiment, the method according to the invention consists of the following steps of:

1) dissolving and mixing a legume protein composition and at least one flavoring in an aqueous solvent;
2) heat-treating the aqueous suspension obtained in the previous step;
3) drying, by co-atomization the aqueous suspension that has been heat-treated.

According to this particular embodiment, the powder recovered after step 3) consists of the legume protein composition and the flavoring. Therefore, it is free of any other compound such as a maltodextrin and/or guar gum.

As mentioned above, the method according to the invention is particularly advantageous because it makes it possible to improve the organoleptic properties of a legume protein composition by reducing the legume flavor, in particular the pea flavor.

This reduction of the legume flavor, in particular of peas, is obtained in a synergistic manner by the combination of three characteristics, namely the mixing of at least one flavoring in the legume protein composition followed by a heat-treatment step and a co-atomization step. Indeed, the combination of these three characteristics allows a greater reduction of the legume flavor, particularly of peas, than the sum of the reductions obtained by these characteristics taken in isolation.

The applicant has thus developed an innovative method for providing legume protein compositions with reduced legume flavor, in particular pea isolates with reduced pea flavor, which can be easily and directly used in food preparations. Advantageously, this makes it possible to substitute part of the animal proteins while reducing the disadvantages generally encountered with plant proteins from legumes.

According to another aspect of the invention, a co-atomized composition is proposed comprising a legume protein composition and at least one flavoring.

The legume protein composition and the flavoring are as previously defined.

The co-atomized composition comprising a legume protein composition and at least one flavoring is obtainable according to the method described above.

The composition according to the invention is advantageous because it has reduced pea flavor and thus makes it possible to improve the organoleptic properties of the food products into which it is incorporated, said products are thus more neutral in the mouth for the consumers.

Advantageously, the co-atomized composition according to the invention makes it possible in particular to substitute in food compositions part of the animal proteins with plant proteins while reducing the disadvantages of using this type of proteins.

According to a final aspect of the invention, the use of the co-atomized composition comprising a legume protein composition and at least one flavoring as previously defined is proposed in preparing human or animal food compositions.

The use according to the invention in compositions intended for human food is advantageous because it makes it possible to reduce the pea flavor in those to which it is added and thus to improve the organoleptic sensation perceived by the consumer.

The invention will be better understood by means of the nonlimiting examples hereinbelow.

### EXAMPLES

### Example 1: Implementation According to the Invention of the Method for Co-Atomization of a Legume Protein Composition and a Flavoring

For this example, the following products are used:
Legume protein composition: Nutralys® S85F pea protein isolate, manufactured and marketed by Roquette Freres.
Flavoring: vanillin-based flavor masker.

Two mixtures with 10% solids are produced with distilled water at 20° C. in the proportions described below:
mixture A (control): 100% Nutralys® S85F.
mixture B: 99.9% Nutralys® and 0.1% flavoring.

The two mixtures are stirred for 30 minutes at pH 7.

Mixtures A and B then undergo a heat-treatment step at 140° C. for 10 seconds. Part of mixture B does not undergo this heat-treatment step and constitutes mixture B′.

Mixtures A, B and B′ are then sprayed on a single-acting NUBILOSA Spray Dryer Type LTC-Q, with 195° C. air inlet temperature and 90° C. air outlet temperature. Powders A, B and B′ thus obtained are recovered for an organoleptic study.

The organoleptic study of the different powders obtained is carried out with the help of a panel and following the protocol hereunder.

The panel consists of 30 persons with 2 to 4 years of training. Their performance is frequently verified in terms of sensitivity, consensus and repeatability.

The tasting matrices consist of suspensions of each of the powders at 4% by weight in Evian® water, homogenized using an immersion mixer, and are listed below:
Matrix 1: Nutralys®
Matrix 2: Nutralys®+0.1% by weight of flavoring
Matrix 3: powder A
Matrix 4: powder B′
Matrix 5: powder B

The tasting conditions are as follows: individual stall, white walls, calm atmosphere, red light, late morning, products coded with 3 digits, presented in a random order, and use of apple and/or water to rinse the oral cavity.

The methodology used is called “BLOCK PROFILING”. This method is referred to as Quantitative Descriptive Analysis (QDA): the panelists score each product (matrix) on a scale of intensity (from 0 to 10) through different indicators that correspond, for example, to tastes, flavors, or particular notes.

The control, identified as “C”, is always presented first and is presented blindly in 1 out of 2 sessions.

The panelists conduct the tasting exercise in blocks: they evaluate each product individually (starting with “C”) in a first block (indicators: salty, bitter, astringent, sandy—with a nose clip), then they analyze all the products in a second block (indicators: pea, broth, walnut, almond). Finally, they repeat the exercise in a third block (indicators: potato, cereal). The products are evaluated in multiple sessions, until reaching 10 evaluations. The arithmetic average of these 10 evaluations is then calculated for each indicator.

The results are presented in Table 1 below for the pea flavor and the salty taste:

TABLE 1

Indicators

| | Pea | Salty |
|---|---|---|
| Control matrix 1: Nutralys ® S85F | 4.45 | 3.37 |
| Matrix 2: Nutralys ® S85F + flavoring | 4.06 | 3.79 |
| Matrix 3: powder A | 4.07 | 4.33 |
| Matrix 4: powder B′ | 4.77 | 3.79 |
| Matrix 5: powder B | 3.73 | 3.14 |

The Nutralys® S85F in matrix 1 and the mixture of Nutralys® S85F and flavoring in matrix 2 were not heated and atomized and serve as a control and comparison, respectively.

For the pea flavor, the results in Table 2 show that simply adding the flavoring to the pea protein isolate (matrix 2) slightly decreases the pea flavor compared to the control. Through matrix 3, it is also observed that the atomization of the pea protein isolate only leads to a reduction in the pea flavor compared to the control, and that said reduction is equivalent to that observed with matrix 2.

Conversely, the results with matrix 4 show that performing the co-atomization of the pea protein isolate and the flavoring does not lead to a reduction in the pea flavor. On the contrary, the latter is even greater than when compared to the control. Performing only the co-atomization on a mixture of pea protein isolate+flavoring therefore leads to an undesirable increase in the pea flavor.

On the other hand, performing a heat-treatment step prior to the co-atomization of the pea protein isolate and the flavoring (matrix 5) leads to a reduction of about 16% of the pea flavor compared to the control and of about 22% compared to performing only the co-atomization of the mixture of the pea protein isolate and the flavoring (matrix 4). Quite surprisingly, this reduction is even greater than that observed with the addition of the flavoring without co-atomization (matrix 2) or with the atomization of the pea protein isolate alone (matrix 3).

These results clearly demonstrate the synergy of adding a flavoring and carrying out a heat-treatment and co-atomization step according to the invention on the reduction of the pea flavor of a pea isolate.

Regarding the salty taste, the results show that the addition of the flavoring to the pea protein isolate (matrix 2) increases this taste. Through matrix 3, it is also observed that the atomization of the pea protein isolate only leads to a reduction of this salty taste compared to the control.

Similarly, the results with matrix 4 show that carrying out the co-atomization of the pea protein isolate and the flavoring leads to an increase in the salty taste.

On the other hand, and quite surprisingly, carrying out a heat-treatment step prior to the co-atomization of the pea protein isolate and the flavoring (matrix 5) leads to a reduction of about 7% of the sweetness compared to the control and of about 17% compared to carrying out only the co-atomization of the pea protein isolate and the flavoring (matrix 4).

These results clearly demonstrate the synergy of adding a flavoring and carrying out a heat-treatment and co-atomization step according to the invention on the reduction of the salty taste of a pea isolate.

In conclusion, the co-atomization method according to the invention makes an organoleptic improvement of the protein isolates possible, and in particular of the pea protein isolates, by means of reducing the pea flavor and the salty taste.

### Comparative Example 2: Implementation of a Method for Co-Atomization of a Legume Protein Composition and a Maltodextrin

This example aims to highlight the effect of co-atomization of a maltodextrin with a pea protein isolate as described in the article Lan et al. “Solid dispersion-based spray-drying improves solubility and mitigates beany flavor of pea protein isolate” (Food Chemistry, 2018). Moreover, unlike in Lan et al the powders obtained are tested organoleptically.

For this example, the following products are used:
Pea protein isolate: Nutralys® S85F product, manufactured and marketed by Roquette Freres.
Pea maltodextrin: KLEPTOSE® LINECAPS product, with a D.E. (dextrose equivalent) of 17, also manufactured and marketed by Roquette Freres.

Two mixtures with 10% solids are produced with distilled water at 20° C. in the proportions described below:
Mixture 1: 100% Nutralys® 585F,
Mixture 2: 95% Nutralys® S85F and 5% pea maltodextrin.

The two mixtures are stirred for at least 30 minutes at pH 7.

The mixtures then undergo heat treatment at 140° C. for 10 seconds before being sprayed on a NUBILOSA Spray Dryer Type LTC-Q, with 195° C. air inlet temperature and 90° C. air outlet temperature.

Powders 1 and 2 obtained from mixtures 1 and 2, respectively, are recovered for an organoleptic study.

The organoleptic study is carried out according to the same protocol as example 1.

The tasting matrices therefore likewise consist of suspensions of each of the powders at 4% by weight in Evian® water, homogenized using an immersion mixer.

The results of the organoleptic study by the panel are presented in Table 2 below:

TABLE 2

Indicators

| | Pea | Bitter |
|---|---|---|
| Control matrix: Nutralys ® S85F | 4.3 | 3.5 |
| Matrix 1: powder 1 | 4.0 | 3.4 |
| Matrix 2: powder 2 | 5.0 | 4.5 |

In the article by Lan et al. maltodextrin is present at a level of 10% by weight (dry/dry) in the mixture.

The results presented in Table 2 with matrix 2 show that with a lower amount of maltodextrin, that is 5% by weight (dry/dry), co-atomization, even with a prior heat-treatment step, does not allow reducing the pea flavor compared to the control. On the contrary, the latter is even increased by about 16%.

The same conclusion is made with the bitter taste.

Therefore, the results show that at a lower level than described by Lan et al., the effect on the reduction of the pea flavor by co-atomization of a pea protein isolate with a maltodextrin is not observed.

These results reinforce the fact that the method according to the invention is particularly advantageous for improving the organoleptic properties, in particular by reducing the flavor of a pea protein isolate, and in particular the pea flavor.

Other tests using, instead of the previous flavoring, other flavorings have also been carried out. The method has been carried out particularly with a maltol-based flavoring and the properties are equally improved. It has also been tested with Cleartaste flavoring (MycoTechnology Inc) and with Vanifolia (Solvay) and, in each test, these properties are also improved.

1-7. (canceled)

8. A method for co-atomizing a legume protein composition and at least one flavoring comprising the following steps of:
1) dissolving and mixing a legume protein composition and at least one flavoring in an aqueous solvent;
2) heat-treating the aqueous suspension obtained in the previous step;
3) drying, by co-atomization the aqueous suspension that has been heat-treated.

9. The co-atomization method according to claim 8, wherein the flavoring is dissolved and mixed with the legume protein composition in an amount of 0.01% to 0.5% by dry weight relative to the total dry weight of the legume protein composition (dry/dry), preferentially between 0.05 and 0.2% by weight (dry/dry), and even more preferentially, in an amount of 0.1% by weight (dry/dry).

10. The co-atomization method according to claim 8, wherein the heat-treatment step is carried out at a temperature of 100° C. to 160° C. and for 0.01 to 10 seconds followed by immediate cooling.

11. The co-atomization method according to claim 8, wherein the legume protein composition is a legume protein isolate, preferably a pea protein isolate.

12. A co-atomized composition comprising a legume protein composition and at least one flavoring obtainable by the method according to claim 8.

13. The co-atomized composition according to claim 12, wherein it consists of a legume protein composition and at least one flavoring.

14. A use of the co-atomized composition according to claim 12, in preparing human or animal food compositions.
